(19) United States
(12) Patent Application Publication
(10) Pub. No.: US 2025/0148281 A1
(43) Pub. Date: May 8, 2025

(54) SYNTHETIC DATA FOR FIBER SENSING TASKS WITH CONTROLLABLE GENERATION AND DIFFERENTIABLE INFERENCE

(71) Applicant: NEC Laboratories America, Inc., Princeton, NJ (US)

(72) Inventors: Shaobo Han, Princeton, NJ (US); Tingfeng Li, Plainsboro, NJ (US); Renqiang Min, Princeton, NJ (US)

(21) Appl. No.: 18/909,467

(22) Filed: Oct. 8, 2024

Related U.S. Application Data
(60) Provisional application No. 63/595,849, filed on Nov. 3, 2023.

(51) Int. Cl. G06N 3/08

(52) U.S. Cl. CPC G06N 3/08

(57) ABSTRACT

Systems and methods include collecting real-world distributed-optic fiber sensing (DFOS) sensing data from a target environment as a reference dataset. A synthetic sketch dataset is constructed as a parameterized computer program. A synthetic waterfall is generated from a deep neural network as an image translator from the sketch waterfall with nonlinear distortions and background noises added. Parameters are optimized for generating the synthetic waterfall under a loss function where the loss function encodes a generalization performance on the real-world dataset and encodes granularities from a sensing process and uncontrollable factors.

### RELATED APPLICATION INFORMATION

This application claims priority to U.S. Provisional Patent Application No. 63/595,849 filed on Nov. 3, 2023, incorporated herein by reference in its entirety.

### BACKGROUND

### Technical Field

The present invention relates to optical fiber sensing, and more particularly, systems and methods that employ synthetically generated optical sensing data to train artificial intelligence (AI) systems, and the use of a data simulator for understanding of optical sensing data, through gradient-based optimization.

### Description of the Related Art

Distributed-optic fiber sensing (DFOS) has been used for a wide range of applications. With machine learning techniques, low-level physical parameters (e.g., vibration/acoustics, temperature, polarization) can be converted into high-level meaningful events (e.g., traffic count, earthquake location, structure health status, cable-cut anomalies, etc.). However, training of generalizable machine learning models and large-scale business deployment in the real-world use cases remains difficult as the cost of human annotation for paired labeled data is very expensive. Labeling data is a tedious, time-consuming, and an error prone process and needs a certain level of domain expertise by a qualified annotator. As a result, the availability of labeled data for machine learning training is often very limited. Further, data collection requires field work and hours of human labor. Creating physical events in the field is difficult (e.g., excavator digging after a rainy day), and sometimes even impossible due to the complexity of the physical phenomena of interest. Due to the high cost of data collection, insufficient resources in the field, and physical constraints, it is often impractical to collect enough training data that can have sufficient coverage of all possible combinations of these conditions.

### SUMMARY

According to an aspect of the present invention, systems and methods include collecting real-world distributed-optic fiber sensing (DFOS) sensing data from a target environment as a reference dataset. A synthetic sketch dataset is constructed as a parameterized computer program. A synthetic waterfall is generated from a deep neural network as an image translator from the sketch waterfall with nonlinear distortions and background noises added. Parameters are optimized for generating the synthetic waterfall under a loss function where the loss function encodes a generalization performance on the real-world dataset and encodes granularities from a sensing process and uncontrollable factors.

According to another aspect of the present invention, a system includes a hardware processor and a memory that stores a computer program. When executed by the hardware processor, the hardware processor is caused to collect real-world distributed-optic fiber sensing (DFOS) sensing data from a target environment as a reference dataset; construct a synthetic sketch dataset as a parameterized program; generate a synthetic waterfall from a deep neural network as an image translator from the sketch waterfall with nonlinear distortions and background noises added; and optimize parameters for generating the synthetic waterfall under a loss function where the loss function encodes a generalization performance on the real-world dataset and encodes granularities from a sensing process and uncontrollable factors.

According to another aspect of the present invention, a computer program product includes a computer readable storage medium storing program instructions embodied therewith, the program instructions executable by a hardware processor to cause the hardware processor to: collect real-world distributed-optic fiber sensing (DFOS) sensing data from a target environment as a reference dataset; construct a synthetic sketch dataset as a parameterized program; generate a synthetic waterfall from a deep neural network as an image translator from the sketch waterfall with nonlinear distortions and background noises added; and optimize parameters for generating the synthetic waterfall under a loss function where the loss function encodes a generalization performance on the real-world dataset and encodes granularities from a sensing process and uncontrollable factors.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high level system/method to generate synthetic waterfalls from synthetically generated distributed-optic fiber sensing (DFOS) data, in accordance with an embodiment of the present invention;

FIG. 2 is a block/flow diagram illustrating the system/method of FIG. 1 in greater detail and showing joint optimization of a simulator, generator, model and discriminator, in accordance with an embodiment of the present invention;

FIG. 3 is a block/flow diagram illustrating a parametrized, probabilistic computer program to form sketch data sets, in accordance with an embodiment of the present invention;

FIG. 4 is a block/flow diagram illustrating generation of datasets and backpropagating descriptions from the system, in accordance with an embodiment of the present invention;

FIG. 5 is a flow diagram illustrating use of synthetic data from trading and optimizing systems/methods, in accordance with an embodiment of the present invention;

FIG. 6 is a block/flow diagram illustrating a system for generating synthetic data for fiber sensing tasks, in accordance with an embodiment of the present invention; and

FIG. 7 is a flow diagram showing methods for generating synthetic data for fiber sensing tasks, in accordance with an embodiment of the present invention.

### DETAILED DESCRIPTION OF PREFERRED EMBODIMENTS

In accordance with embodiments of the present invention, systems and methods are described that provide a learning approach with a differentiable simulator, which can take various high-level text descriptions as input, and generate a diverse set of synthetic waterfall images to boost performance on downstream tasks with real-world fiber sensing data. Data variations can be decomposed. For example, the simulator can capture the variations caused by controllable and interpretable factors (such as the number of vehicles, the driving speed, the number of hits of an excavator), and its parameters are directly optimized based on a validation loss on the real-world dataset in an end-to-end manner. The complex and uncontrollable factors can be learned by a deep generative model, and trained under an auxiliary loss which encourages synthetic data closely resembling fiber sensing data.

The data generative process can include a simulator and a neural network decoder, with disentanglement of controllable and uncontrollable factors that are common in fiber sensing data. A loss function can emphasize photorealism and downstream task performance. The simulator and the neural network parameters can be optimized in a differentiable manner. The present embodiments supports unsupervised domain adaptation using reference unlabeled real-world datasets, where data generative processes can be customized to different routes.

The present embodiments enable paired data with annotations to facilitate machine learning training (e.g., Sim2Real transfer) and can incorporate strong inductive bias (simulator) for generalization from limited data. Conditional, controllable, and procedure data generation can be provided with adaptation to a target domain using only unlabeled data. The present embodiments can also be employed for waterfall scene understanding, by performing a backpropagation of the neural network.

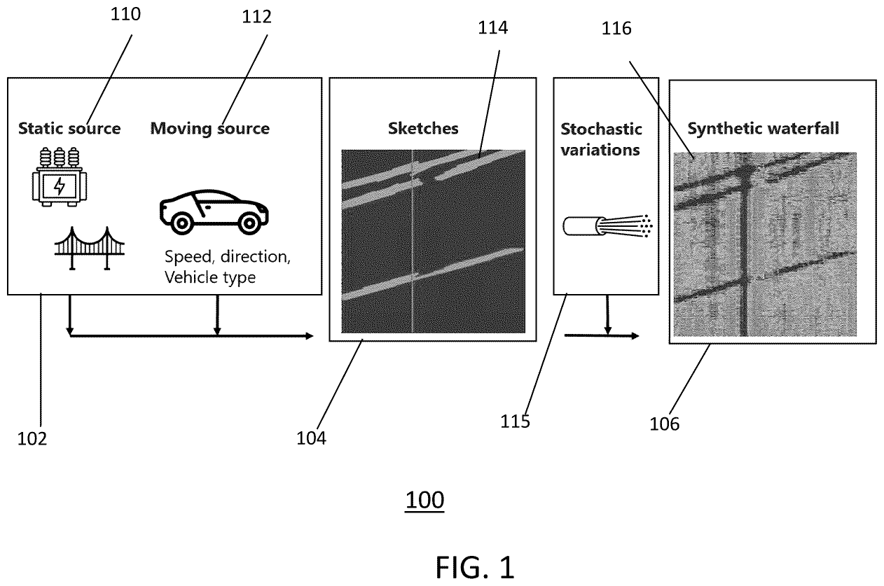

Referring now in detail to the figures in which like-numerals represent the same or similar elements and initially to FIG. 1, a system 100 for simulating distributed optical fiber sensing (DFOS) in accordance with embodiments of the present invention. The present invention can leverage the flexibility and expressive power of a computer program simulator 102 and deep generative models or generator 106, to simulate the complex processes of DFOS sensing. DFOS senses physical events including shock and vibration events and modulates a light signal with a fiber optic cable to convert the modulated light signal into digital data at light speed.

Changes or signatures in the signal can identify information about the physical event. For example, buried DFOS sensors can be employed to detect activities, such as digging, vehicles passing, etc. There are several influence factors that affect the signals generated. For example, influence factors can include a vibration source, a propagation medium, a cable type, a sensor configuration, etc.

The present embodiments provide a way to mimic complex data generation to increase accuracy and robustness of DFOS systems. In an embodiment, the data generation process includes the computer program simulator 102 as a physics engine and the deep generative model 106 as a graphics engine. There are two major types of vibration sources. These can include a static source 110 (e.g., an electricity generator, an electric transformer, a bridge) and moving sources 112 (e.g., vehicles). A high-level text description of the static sources 110 can include a number and type of sources, vibration frequency, intensity, influence range, and, for moving sources 112, the high-level text description can include a direction of movement and speed of objects (e.g., vehicles). The computer program simulator 102 (or simply simulator) takes a text description input and outputs a sketch 114 that complies with the description. The sketch can include vibrational information in accordance with text description. In an example, the sketch can show a vibrational response for a bridge.

Uses can include a number of practical applications, for example, cable cut prevention for telecom carriers, perimeter intrusion detection for key facility owners, traffic sensing for department of transportation or highway owners, etc. In an embodiment, the simulator 102 can simulate different digging patterns for a digging machine monitored using an underground fiber optic cable. High-level text description can be generated and can include a number of hits with the digger, the duration of the hits, and time lapse between hits, etc. Another application can include perimeter intrusion detection, where one is interested in detecting human presence by detecting walking or running patterns using a fiber optic cable. This can be used to simulate a variety of walking patterns and behaviors from different people.

In another application, traffic sensing and accident detection can be performed. Here, one is interested in a number of traffic traces, slope, width, and acceleration/deceleration patterns. To detect traffic accidents, normal traffic traces can be used to establish a baseline model. A high-level text description can be used as input to the control the data generated in a fine-grained manner, to be more relevant and useful.

The deep generative model 106 further translates the sketch 114 into a realistic waterfall image 116, by adding stochastic variations. Stochastic variations are vibrational variations that can randomly occur. This can include a transfer function from an acoustic/vibration signal to a phase change of a distributed acoustic sensing (DAS) optical signal, nonlinear effect of pulse width, gauge length, and unknown background noises, which can be included in the waterfall image 116 as well as other variations. The waterfall image 116 is synthetically generated and closely resembles real-world fiber sensing data.

Waterfall images, also referred to as cascade plots or spectral maps, show how vibration frequencies change over time and can include a series of spectrums placed one behind the other to generate a 2-dimensional graph where the generated data has two dimensions, the y-axis can correspond to time and x-axis can correspond to location.

Data annotation for training and evaluating fiber sensing AI models is expensive. Utilizing unlabeled waterfall data, the present invention can generate realistic looking synthetic waterfall images paired with ground truth labels. In addition, running the trained model backward as an inference tool, the waterfall scene can be explained with high-level descriptions that can differentiate between different sources.

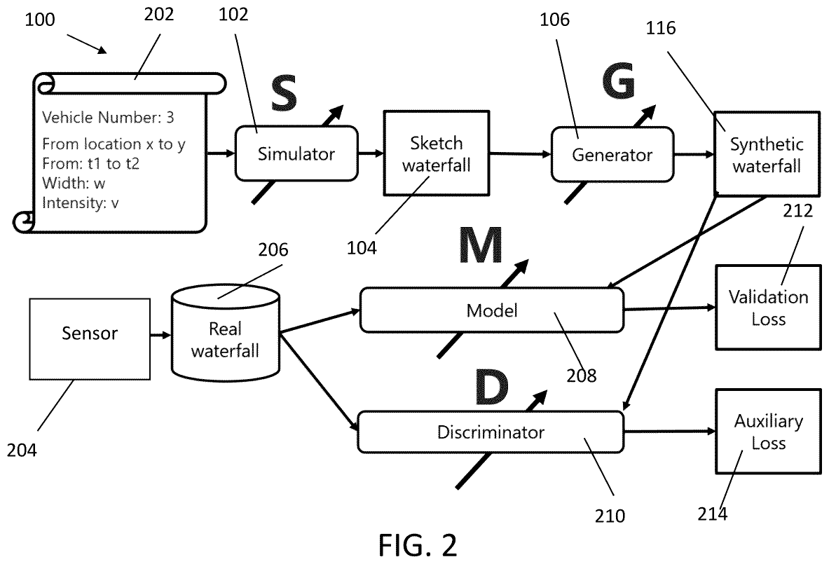

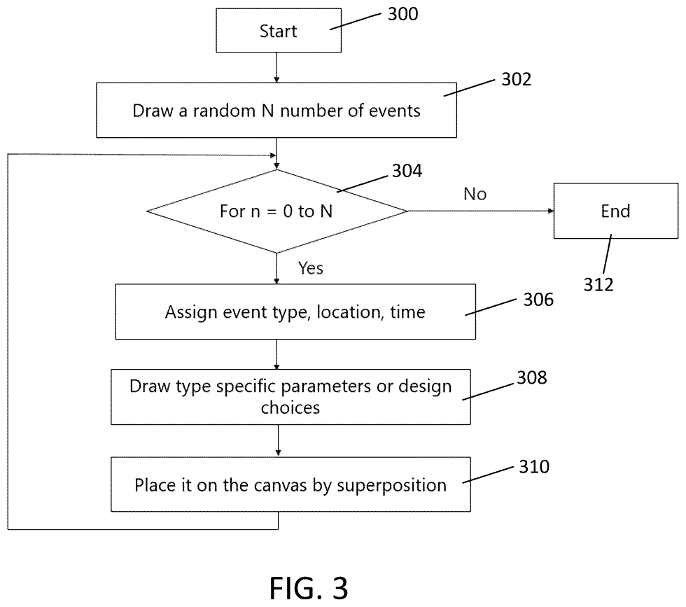

Referring to FIG. 2, training the system 100 can include collecting real-world DFOS sensing data from a target environment as a reference dataset 202. This can include signals related to static sources 110 and moving sources 112 related to an environment in which the system 100 will be inferenced in operation. In an example, the reference dataset 202 can include information like: a number of vehicles (3), from a location x to y for time t1 to t2 with a pulse width of w and an intensity v, etc. A synthetic sketch dataset 104 of sketches 114 is constructed as an intermediate representation. The physical engine provided by the simulator 102 can be written as a parameterized computer program with control, loop, and recursion statements. The parameters inside the simulator 102 can be fine-tuned with gradient-based optimization under a loss function. The sketch generation process via a probabilistic program will be described in greater detail with reference to FIG. 3.

The synthetic waterfall 116 can be generated by the deep generative model referred to as a generator 106 (neural network) as an image translation from a sketch waterfall or synthetic sketch dataset 104 to the synthetic waterfall 116, with nonlinear distortions and background noises added (e.g., stochastic variations 115).

The parameters of the generator 106, as well as the simulator 102, a model 208 for downstream tasks and a discriminator 210 for adversarial training are optimized under a validation loss function 212. The validation loss function 212 explicitly encodes a generalization performance on a real-world dataset 206, and additionally an auxiliary loss 214 is employed to encourage the generator 106 to capture granularities from a sensing process by sensors 204 and uncontrollable factors. The discriminator 210 distinguishes between real and generated images, while the generator 106 aims to produce images that deceive the discriminator 210.

After the model 208 has been trained, the model 208 can be used for predicting downstream tasks. For example, the model 208 can be directly applied to predict or characterize activities, e.g., identify an approach of vehicle, etc. in a target domain, e.g., Sim2Real transfer. In another application, scene understanding can be utilized. For example, given a query waterfall image, backpropagation can be run through generator 106 and simulator 102 to obtain a higher-level description of the scene. For example, a language description (e.g., human understandable) of the waterfall image. This is a simulator based inference and provides a differentiable inference in accordance with present embodiments.

The system 100 can be employed to generate new datasets with unseen attributes (e.g., controlled and compositional generation). The new dataset can include attributes that outside of the real data collected and can take advantage of simulated events to create the new datasets. Synthetic datasets can also be created. The synthetic waterfall dataset can be paired with a rich text description, which can be used for other machine learning tasks.

Referring to FIG. 3, a sketch generation method via probabilistic programming is described. The method begins with block 300 and proceeds to block 302 where a random number of events are drawn or sketched. These events can be from a number of sources as described with reference to FIG. 1. In block 304, a loop is initialized for iteratively addressing each event drawing from block 302. In block 306, the drawing is assigned an event type, location and time. In block 308, type specific parameters are drawn, type specific parameters can include vibration response information. The type of parameters selected can be determined based on design choice of the user and/or based on applications of the system. In block 310, each drawing is accumulated on a canvas which superimposes each drawing event thereon to provide a sketch waterfall image. The process ends in block 312 when the last event N is reached.

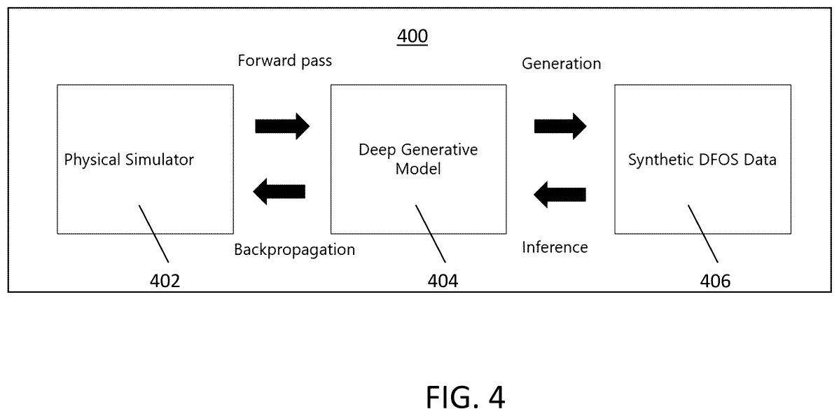

Referring to FIG. 4, a block/flow diagram shows a differentiable physical simulator 402 and simulation-based inference (“inference”) via gradient-based optimization. The reversible capabilities of the system in accordance with the present invention permits a number of useful functions. For example, conditional data generation (synthetic data), calibration of physical simulator inferences with reference to real-world data and simulation-based inferences are handled in a unified framework, with forward execution (forward pass) and backpropagation.

Differentiable simulation enables optimization for control, and can also be integrated into neural network frameworks in deep generative models 404 for performing complex tasks. Differentiable modeling involves connecting (flexible amounts of) prior physical knowledge to neural networks and offers better interpretability, generalizability, and extrapolation capabilities than purely data-driven machine learning, achieving a similar level of accuracy while requiring less training data. Additionally, the performance and efficiency of differentiable models scale well with increasing data volumes. Under data-scarce scenarios, differentiable models have outperformed machine-learning models in producing short-term dynamics and decadal-scale trends owing to the imposed physical constraints. Synthesis DFOS data 406 is generated to train the deep generative model(s) 404, which can use real data as well as synthetic data. A transformation is enabled between plotting acoustic information as waterfalls to verbal descriptions of the acoustic information. Embodiments can than take acoustic data collected from a fiber optics cable and verbally describe or textually describe the acoustic information. This can be done in real-time.

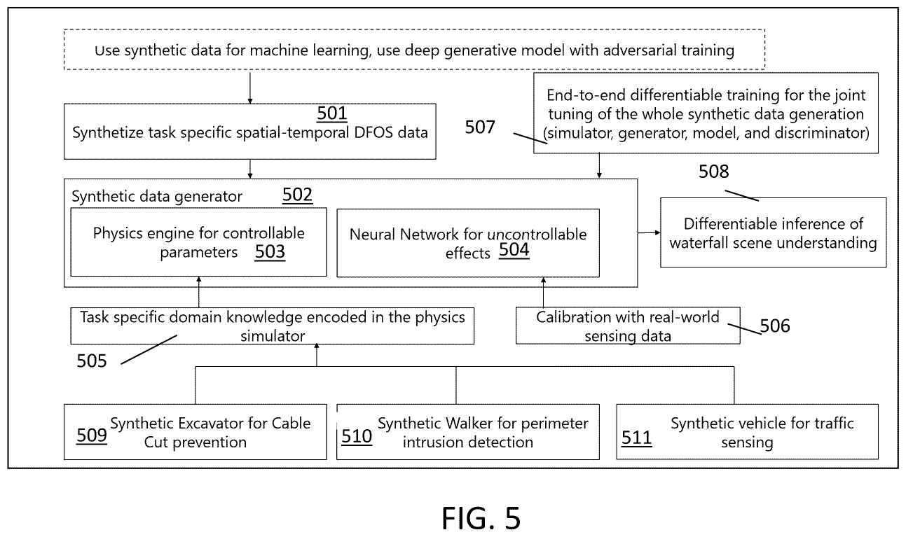

Referring to FIG. 5, a block/flow diagram shows implementations using synthetic data machine learning using deep generative models with adversarial training in accordance with embodiments of the present invention. In block 101, data is synthesized in a special modality of DFOS data, e.g., 2D spatial-temporal format waterfall data, for a number of applications. A synthetic generator 502 can employ a probabilistic computer program in a physics engine 503 to generate sketch waterfalls, given high-level descriptions of event information. The use of random seeds generates a variety of events and covers different combinations of scenarios. Parameters of this simulator or synthetic generator 502 can be learned by gradient updating of discrete variables. The physics engine 503 is employed with controllable parameters, e.g., sources in blocks 509, 510, 511, etc. Neural networks in block 504 can be employed for uncontrollable effects, e.g., from block 506.

In block 505, domain knowledge can be distilled from humans or other sources to the data simulation procedures and provide parameters as input to the physics engine 503. These distillations can be from one or more practical applications. For example, in block 509, synthetic digging patterns in cable cut prevention operations can be employed as an input. In block 510, synthetic walking patterns in perimeter intrusion detection application can be provided. In block 511, synthetic traffic traces in traffic sensing and accident detection application can be provided.

The synthetic data generator 502 can provide disentanglement of controllable factors (e.g., from acoustic events) and uncontrollable factors (e.g., from sensors and the environment), explicitly, in a data generation process backed up by differentiable probabilistic programming and deep generative models.

In block 504, a deep neural network is used to translate sketch waterfalls into synthetic waterfalls, which additionally captures the complex and uncontrollable factors from the sensor configuration and external environments. In block 506, the calibration process is conducted with reference to real-world sensing data collected in a targeted deployment environment.

In block 507, joint optimization of parameters is provided for the simulator, generator, task model, and discriminator, with differentiable gradient updates and end-to-end training, as opposed to handling it in separated, non-differentiable procedures or reinforcement learning. In block 508, the use of the trained model for not only forward data generation, but also backward inference and waterfall scene understanding can be employed. Given a query waterfall image, backpropagation through the generator can get a sketch waterfall, which summarizes the main elements in the waterfall. Furthermore, backpropagation through the simulator can yield human understandable descriptions of the scene in text format.

The flexibility and expressive power of the computer simulator and deep generative models are employed to simulate the complex process of DFOS sensing. DFOS turns physical events into digital data at light speed.

In cable cut prevention in block 507, excavator machines working near a cable need to be detected. The present embodiments can be employed to simulate different digging patterns. The high-level text description can further include a number of hits, a duration, and time lapse between hits. In perimeter intrusion detection in block 510, one is interested in human presences and walking patterns are detected in, e.g., a security application. The present embodiments can be employed to simulate a variety of walking patterns and behaviors from different people. In traffic sensing and accident detection in block 511, one is interested in the number of traffic traces, the slope, the width, and whether there are acceleration or deceleration patterns. To detect traffic accidents, the normal traffic traces can be used to establish a baseline model. The high-level text description can be used as input to control the data generated in a fine-grained manner, such that they are more relevant and useful.

Data annotation for training and evaluating fiber sensing AI models is expensive. Utilizing unlabeled waterfall data, the proposed approach can generate realistic looking synthetic waterfall paired with ground truth labels. In addition, running the trained model backward as an inference tool, the waterfall scene can be explained with high-level descriptions.

While applications such as, e.g., cable cut prevention for telecom carriers, perimeter intrusion detection for key facility owners, traffic sensing for department of transportation or highway owners have been described, the present embodiments are not limited to these applications. Other applications are also contemplated.

The performance of the deployed machine learning systems in the real-world are severely affected by unknown environmental factors and sensor configurations. Therefore, it is of interest to generate physically plausible fiber sensing data with annotations with a simulator for machine learning training. However, the variety of data generated (events, actions, environment) are often limited. In addition, there is a gap between the data synthesis, and the real-world sensing data. As a result, there could be a performance drop when applying models trained on synthetic data to the real-world tasks.

Artificial Machine learning systems can be used to predict outputs or outcomes based on input data, e.g., fiber optic acoustic data. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

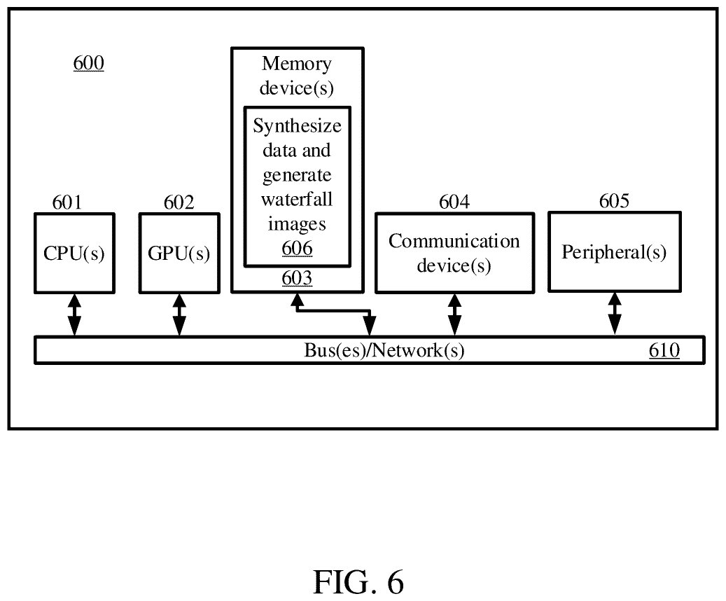

Referring to FIG. 6, a block diagram is shown for an exemplary processing system 600, in accordance with an embodiment of the present invention. The processing system 600 includes a set of processing units (e.g., CPUs) 601, a set of GPUs 602, a set of memory devices 603, a set of communication devices 604, and a set of peripherals 605. The CPUs 601 can be single or multi-core CPUs. The GPUs 602 can be single or multi-core GPUs. The one or more memory devices 603 can include caches, RAMs, ROMs, and other memories (flash, optical, magnetic, etc.). The communication devices 604 can include wireless and/or wired communication devices (e.g., network (e.g., WIFI, etc.) adapters, etc.). The peripherals 605 can include a display device, a user input device, a printer, an imaging device, and so forth. Elements of processing system 600 are connected by one or more buses or networks (collectively denoted by the figure reference numeral 610).

In an embodiment, memory devices 603 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 603 store program code for implementing one or more functions of the systems and methods described herein for programmed software 606 for generating synthetic data and generating waterfall image. The memory devices 603 can store program code for implementing one or more functions of the systems and methods described herein.

Of course, the processing system 600 may also include other elements (not shown), as readily contemplated by one of skill in the art, as well as omitting certain elements. For example, various other input devices and/or output devices can be included in processing system 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 600.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data

processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

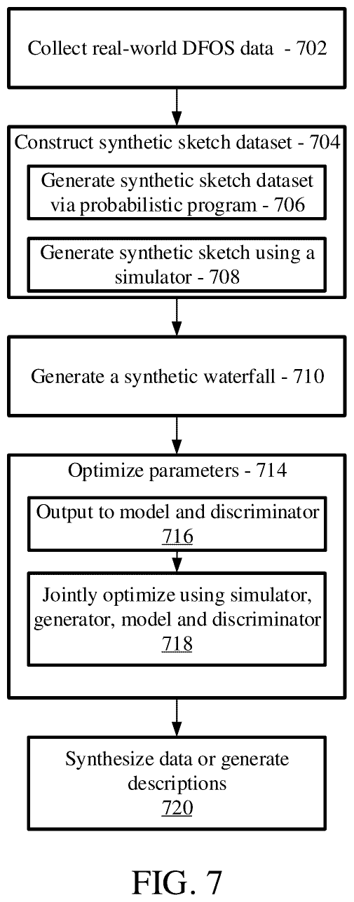

Referring to FIG. 7, a computer-implemented methods for generating synthetic data in accordance with embodiments of the present invention. In block 702, real-world distributed-optic fiber sensing (DFOS) sensing data is collected from a target environment as a reference dataset. The target environment can be a construction site, traffic, an airport, etc. The DFOS sensing data can describe acoustic events monitored on a cable. Although other sensors can be employed.

In block 704, a synthetic sketch dataset is constructed as a parameterized computer program. In block 706, the synthetic sketch dataset can be generated via a probabilistic program with control, loop, and recursion statements. In block 708, the synthetic sketch dataset can be generated using a simulator. The simulator can include parameters fine-tuned with gradient-based optimization under a loss function.

In block 710, a synthetic waterfall (image) is generated from a deep neural network as an image translator from the sketch waterfall with nonlinear distortions and background noises added.

In block 714, parameters are optimized for generating the synthetic waterfall under a loss function where the loss function encodes a generalization performance on the real-world dataset and encodes granularities from a sensing process and uncontrollable factors.

In block 716, the synthetic waterfall is output, by a generator, to a downstream task model and to an adversarial training discriminator which optimize loss on the real-world dataset. In block 718, optimization of the parameters can be jointly performed on the simulator, the generator, the downstream task model and the adversarial training discriminator.

In block 720, employ system to synthesize data or generate descriptions. For example, backpropagating can be provided to obtain a synthetic sketch dataset from a synthetic waterfall. Further backpropagation can generate a textual description of the synthetic sketch dataset (see e.g., FIG. 4).

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
collecting real-world distributed-optic fiber sensing (DFOS) sensing data from a target environment as a reference dataset;
constructing a synthetic sketch dataset as a parameterized computer program;
generating a synthetic waterfall from a deep neural network as an image translator from the synthetic sketch dataset with nonlinear distortions and background noises added; and
optimizing parameters for generating the synthetic waterfall under a loss function where the loss function encodes a generalization performance on the reference dataset and encodes granularities from a sensing process and uncontrollable factors.

2. The method of claim 1, wherein constructing the synthetic sketch dataset includes generating the synthetic sketch dataset via a probabilistic program with control, loop, and recursion statements.

3. The method of claim 1, wherein constructing the synthetic sketch dataset includes generating the synthetic sketch dataset using a simulator, the simulator including parameters fine-tuned with gradient-based optimization under a loss function.

4. The method of claim 3, wherein the synthetic waterfall is output, by a generator, to a downstream task model and to an adversarial training discriminator which optimize loss on the reference dataset.

5. The method of claim 4, wherein optimizing the parameters is jointly performed on the simulator, the generator, the downstream task model and the adversarial training discriminator.

6. The method of claim 1, further comprising backpropagating a synthetic waterfall to obtain a synthetic sketch dataset.

7. The method of claim 1, further comprising backpropagating a synthetic sketch dataset to obtain a textual description described by a synthetic sketch dataset.

8. The method of claim 1, wherein the DFOS sensing data describes acoustic events monitored on a cable.

9. A system, comprising:
a hardware processor; and
a memory that stores a computer program which, when executed by the hardware processor, causes the hardware processor to:
collect real-world distributed-optic fiber sensing (DFOS) sensing data from a target environment as a reference dataset;
construct a synthetic sketch dataset as a parameterized program;
generate a synthetic waterfall from a deep neural network as an image translator from the synthetic sketch dataset with nonlinear distortions and background noises added; and
optimize parameters for generating the synthetic waterfall under a loss function where the loss function encodes a generalization performance on the reference dataset and encodes granularities from a sensing process and uncontrollable factors.

10. The system of claim 9, wherein the computer program further causes the hardware processor to construct the synthetic sketch dataset by generating the synthetic sketch dataset via a probabilistic program with control, loop, and recursion statements.

11. The system of claim 9, wherein the computer program further causes the hardware processor to construct the synthetic sketch dataset by generating the synthetic sketch dataset using a simulator, the simulator including parameters fine-tuned with gradient-based optimization under a loss function.

12. The system of claim 11, wherein the synthetic waterfall is output, by a generator, to a downstream task model and to an adversarial training discriminator which optimize loss on the real-world dataset.

13. The system of claim 12, wherein the computer program further causes the hardware processor to optimize the parameters jointly on the simulator, the generator, the downstream task model and the adversarial training discriminator.

14. The system of claim 9, wherein the computer program further causes the hardware processor to backpropagate a synthetic waterfall to obtain a synthetic sketch dataset.

15. The system of claim 9, wherein the computer program further causes the hardware processor to backpropagate a synthetic sketch dataset to obtain a textual description described by a synthetic sketch dataset.

16. The system of claim 9, wherein the DFOS sensing data describes acoustic events monitored on a cable.

17. A computer program product, the computer program product comprising a computer readable storage medium storing program instructions embodied therewith, the program instructions executable by a hardware processor to cause the hardware processor to:
collect real-world distributed-optic fiber sensing (DFOS) sensing data from a target environment as a reference dataset;
construct a synthetic sketch dataset as a parameterized program;
generate a synthetic waterfall from a deep neural network as an image translator from the synthetic sketch dataset with nonlinear distortions and background noises added; and
optimize parameters for generating the synthetic waterfall under a loss function where the loss function encodes a generalization performance on the reference dataset and encodes granularities from a sensing process and uncontrollable factors.

18. The computer program product of claim 17, wherein the computer program product further causes the hardware processor to construct the synthetic sketch dataset by generating the synthetic sketch dataset via a probabilistic program with control, loop, and recursion statements.

19. The computer program product of claim 17, wherein the computer program product further causes the hardware processor to construct the synthetic sketch dataset by generating the synthetic sketch dataset using a simulator, the simulator including parameters fine-tuned with gradient-based optimization under a loss function, wherein the synthetic waterfall is output, by a generator, to a downstream task model and to an adversarial training discriminator which optimize loss on the reference dataset wherein the parameters are optimized jointly on the simulator, the generator, the downstream task model and the adversarial training discriminator.

20. The computer program product of claim 17, wherein the computer program product further causes the hardware processor to: backpropagate a synthetic waterfall to obtain a synthetic sketch dataset or a textual description.
